(19) United States
(12) Patent Application Publication
(10) Pub. No.: US 2019/0109640 A1
(43) Pub. Date: Apr. 11, 2019

(54) METHOD AND SYSTEM FOR COMMISSIONING A LIGHTING SYSTEM

(71) Applicant: General Electric Company, Schenectady, NY (US)

(72) Inventors: David Christopher SHILLING, Cleveland, OH (US); Dennis S. BRADLEY, Cleveland, OH (US); Laszlo Sandor ILYES, Richmond Heights, OH (US); Corneliu SARAMET, Burnaby (CA)

(21) Appl. No.: 16/106,026

(22) Filed: Aug. 21, 2018

Related U.S. Application Data
(60) Provisional application No. 62/570,387, filed on Oct. 10, 2017.

(51) Int. Cl. H04B 10/116; H04L 29/12; H04L 12/24

(52) U.S. Cl. CPC H04B 10/116; H04L 41/0806; H04L 61/10

(57) ABSTRACT

A light commissioning system is provided. The system includes a processor and a memory having instructions stored thereon. The instructions, when executed by the processor, cause the processor to perform certain operations. The operations include receiving a signal indicative of a network address of a luminaire. The luminaire may include a visible light communication module configured to encode information indicative of the network address associated with the luminaire into a pattern of light pulses representative of the network address. Further, receiving the signal includes transducing the pattern of light pulses into the signal via a sensor coupled to the processor and routing the signal to the processor. The operations further include generating a database entry in a database accessible the processor, wherein the database entry associates the information indicative of the network address with a physical address of the luminaire.

### TECHNICAL FIELD

The present disclosure generally relates to lighting systems. More particularly, the present disclosure features a method and a system for commissioning a lighting system.

### BACKGROUND

The cost of commissioning a wireless lighting control system adds to the total cost of ownership of such a system. In fact, commissioning complexity is often cited as one of the primary factors preventing wider deployment of such energy-saving technologies. One of the main sources of complexity in this commissioning process is identifying in what physical location each of the wireless node network addresses can be found. For example, in order to zone a group of luminaires in a particular office to be controlled together, the commissioning agent will need to identify which network address corresponds to each one of the luminaires in that office.

There are two traditional solutions to this problem. The first solution, suitable for smaller scale networks, involves issuing a wireless command such that a particular node will begin to identify itself through an audible or visible indication. The commissioning agent will locate that node and record its physical location in a database. The second solution, suitable for larger scale networks, involves marking the wireless network address of each node on the product using a barcode. The commissioning agent will record the location in which the node was installed during deployment. This process has been found to be error-prone and expensive due to increased installation times.

### SUMMARY

One example embodiment provides a system for commissioning a lighting system. The system includes a processor and a memory having instructions stored thereon. The instructions, when executed by the processor, cause the processor to perform certain operations. The operations include receiving a signal indicative of a network address of a luminaire. The luminaire may include a visible light communication module configured to encode information of the network address associated with the luminaire into a pattern of light pulses. Further, receiving the signal includes transducing the pattern of light pulses into the signal via a sensor coupled to the processor and routing the signal to the processor. The operations further include generating a database entry in a database accessible the processor, wherein the database entry associates the information indicative of the network address with a physical address of the luminaire.

Another example embodiment provides a method of commissioning a luminaire. The method includes receiving, by a commissioning device, a signal indicative of a network address of the luminaire. The luminaire includes a visible light communication module configured to encode information indicative of the network address associated with the luminaire into a pattern of light pulses. As such, receiving the signal includes transducing the pattern of light pulses to obtain the signal via a sensor coupled to the commissioning device and routing the signal to the commissioning device. The method further includes generating, by the commissioning device, a database entry in a database accessible the commissioning device, wherein the database entry associates the information indicative of the network address with a physical address of the luminaire.

Another example embodiment provides a non-transitory computer-readable medium including instructions that, when executed by a processor, cause the processor to perform certain operations. The operations include receiving a signal indicative of a network address of a luminaire including a visible light communication module configured to encode information indicative of the network address associated with the luminaire into a pattern of light pulses. As such, receiving the signal includes transducing the pattern of light pulses into the signal via a sensor coupled to the processor and routing the signal to the processor. The operations further include generating a database entry in a database accessible the processor, where the database entry associates the information indicative of the network address with a physical address of the luminaire.

Additional features, modes of operations, advantages, and other aspects of various embodiments are described below with reference to the accompanying drawings. It is noted that the present disclosure is not limited to the specific embodiments described herein. These embodiments are presented for illustrative purposes only. Additional embodiments, or modifications of the embodiments disclosed, will be readily apparent to persons skilled in the relevant art(s) based on the teachings provided.

### BRIEF DESCRIPTION OF THE DRAWINGS

Illustrative embodiments may take form in various components and arrangements of components. Illustrative embodiments are shown in the accompanying drawings, throughout which like reference numerals may indicate corresponding or similar parts in the various drawings. The drawings are only for purposes of illustrating the embodiments and are not to be construed as limiting the disclosure. Given the following enabling description of the drawings, the novel aspects of the present disclosure should become evident to a person of ordinary skill in the relevant art(s).

FIG. 1 illustrates an example environment in which embodiments of the present disclosure may be used.

FIG. 2 illustrates a commissioning device according to an embodiment.

FIG. 3 depicts a flow chart of a commissioning method according to an embodiment.

### DETAILED DESCRIPTION

While the illustrative embodiments are described herein for particular applications, it should be understood that the present disclosure is not limited thereto. Those skilled in the art and with access to the teachings provided herein will recognize additional applications, modifications, and embodiments within the scope thereof and additional fields in which the present disclosure would be of significant utility.

Some example embodiments can be in the form of a commissioning method being executed by a commissioning device, a system having a processor configured to execute the commissioning method, or of a non-transitory computer-readable medium that can configure a processor to perform the commissioning method. For example, an exemplary method may include a first step in which each luminaire is enabled with visible light communication (VLC) broadcast technology.

This technology allows the luminaire to broadcast an identifier (ID) via a pattern of modulated light which can be decoded by a commissioning device equipped with a camera, or generally with a light sensor, and decoding software. In one example, the commissioning device may be a smartphone that is configured with the decoding software. The VLC ID may be uniquely paired with the network address of the luminaire, and as such, the VLC ID may be considered to be information that is indicative of the network address of the luminaire.

Each luminaire is assigned a VLC ID, either during assembly or onsite via an ad hoc wireless network. When the VLC ID is assigned, the corresponding lighting control system wireless node address is also recorded. The wireless network used to assign the VLC IDs may not be same which that is used for lighting control. In such an embodiment, a BLUETOOTH® mesh network may be used for VLC ID assignment.

In a second step, a commissioning agent use an application enabled with VLC-decoding technology to commission the lighting control system. The user interface of the application will guide the agent through the process, and the VLC technology will be used to identify each luminaire. For example, if the commissioning agent wants to create a zone of grouped luminaires in a particular office, he or she will enter a name for the zone in the application. Then, the agent will hold the phone briefly under each luminaire in the zone in order to allow the VLC code to be read. The software will use a database to match each VLC code with a wireless node address which can be passed to the lighting control system.

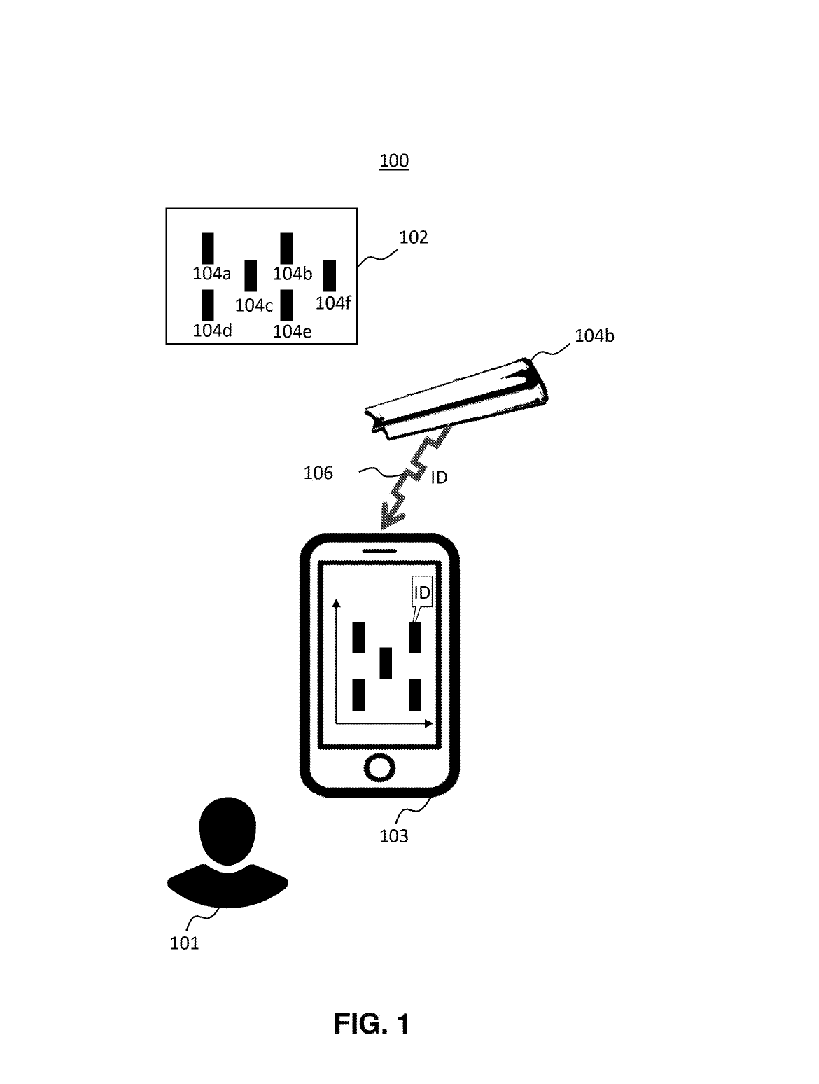

FIG. 1 illustrates an environment 100 in which an exemplary system may be used. The environment 100 includes a room 102 in which a plurality of luminaires (104a, 104b, 104c, 104d, 104e, and 104f) are disposed. One or more of (or each of) the luminaires may include a VLC module. This VLC module can provide indoor positioning functionality to each of the luminaire, thus allowing a system manager to gauge the occupancy of the room 102. In one embodiment, as is described in the context of the luminaire 104b, the VLC module may also be configured to provide, upon request from a commissioning agent 101 or continuously, a light stream 106 indicative of a network address of the luminaire 104b. The network address may be pre-programmed into a memory location of the luminaire 104b as a factory setting during assembly or via a wireless link (i.e., a mesh radio network, BLUETOOTH®, or via an infrared link) using an ad hoc network.

The light stream 106 may be achieved by driving a LED source with a collection of ON and OFF sequences that encode the network address of the luminaire 104b. Alternatively, a signal driving the LEDs of the luminaire 104b can be modulated with the ON and OFF sequence in order to superimpose the light stream 106 on top the light emanating from the luminaire 104b. Nevertheless, in either case, the light stream 106 is invisible to the human eye, as its pulsing frequency is selected so that the ON and OFF states of light stream 106 remain undetectable to the human eye. Thus, to an occupant of the room, the light out of the plurality of luminaires is temporally steady even if one or more luminaire is transmitting a network address via the light stream 106.

A suitable detector, for e.g., a detector that is incorporated within a commissioning device 103, can transduce the light emanating from the luminaire 104b into a signal, which can subsequently be demodulated to create a signal that is indicative of the network address. In one embodiment, the commissioning device may be implemented using a smart phone, and the smart phone's camera may be used as the aforementioned detector.

In one embodiment, a commissioning device or system may include a decoding application that programs a processor to decode the transduced signal and extract the network address. The application may also configure the processor to access a back-end database that includes a list of positions associated with the room 102. The application may then instruct the processor to generate, overwrite, or write a database entry that associates the network address extracted from the light stream 106 with a position corresponding to the luminaire 104b that is already present in the database.

Furthermore, the application may configure to the processor to associate the network address of the luminaire 104b with a particular zone, in addition to associating with a pre-recorded position in the database. For example, the network address of the luminaire 104b may be associated with a zone that includes all of the rooms adjacent to the room 102, where the zone indicates a group of luminaires that may be controlled using a single switch or light controller.

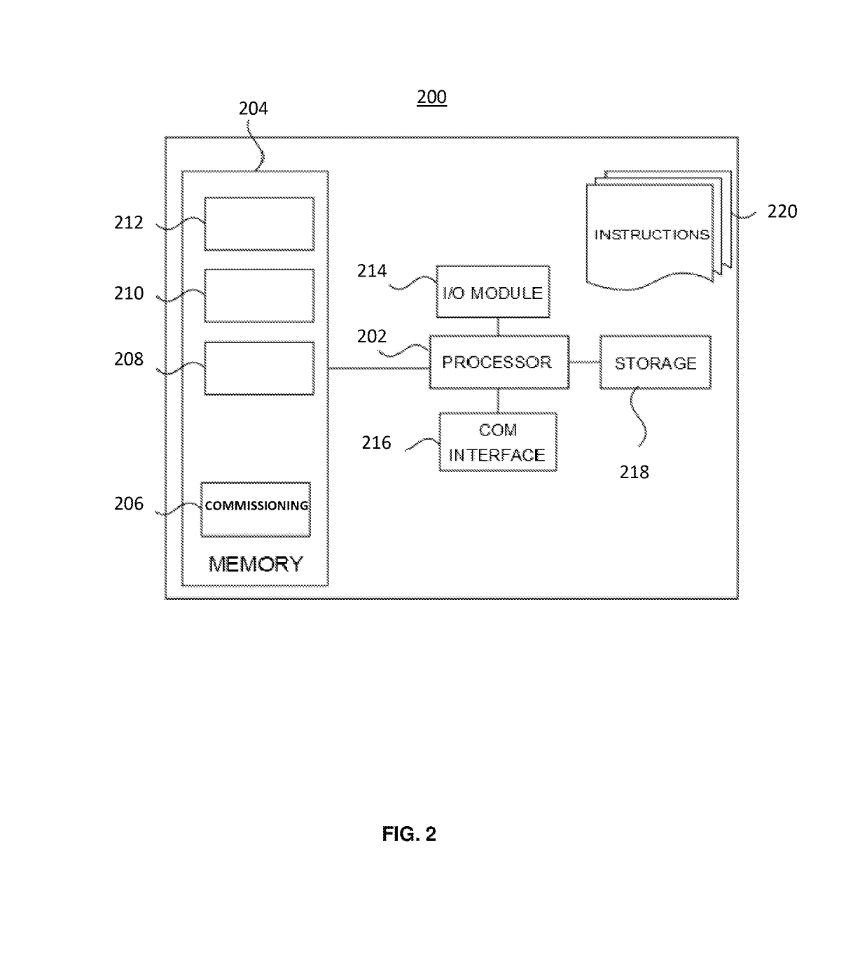

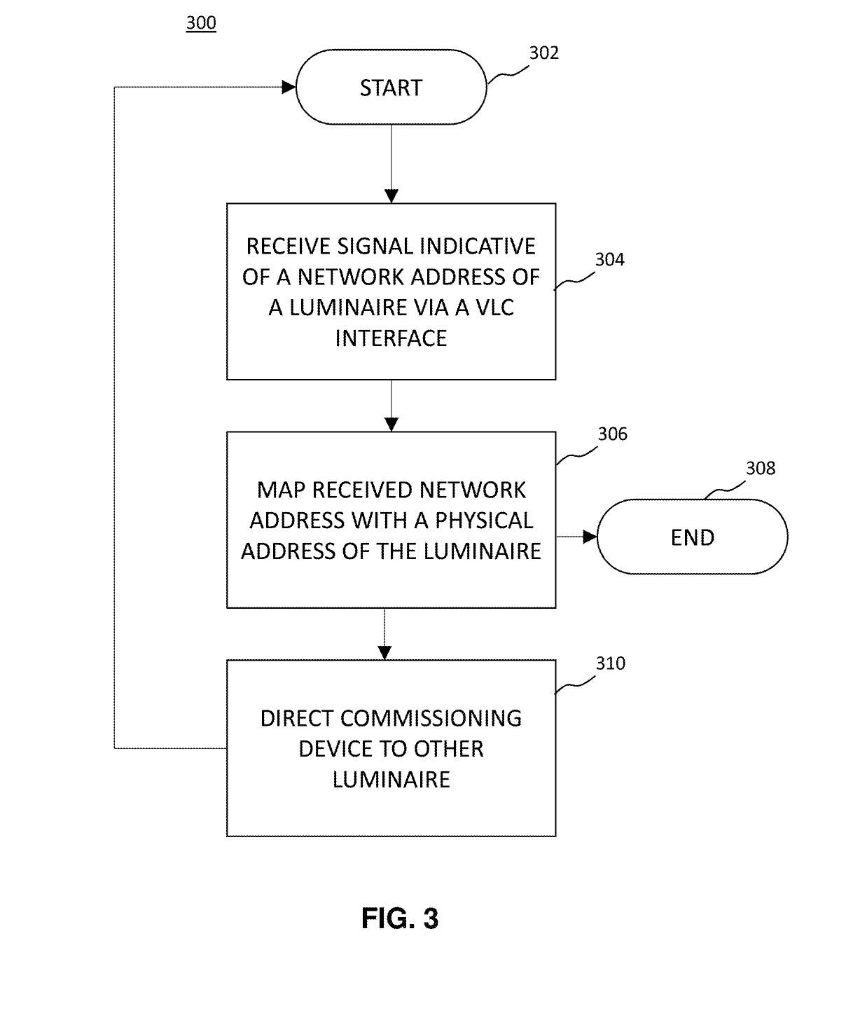

Having described the environment 100 in which an exemplary system and/or method can be used, an exemplary commissioning device or system and an exemplary commissioning method are discussed in relation to FIG. 2 and FIG. 3, respectively.

FIG. 2 illustrates a controller 200 that may be part of a commissioning device or system for use in the environment 100. FIG. 2 shows a block diagram of the controller 200 that includes a processor 202 having an application-specific structure. The application-specific structure can be imparted to processor 202 by instructions stored in a memory 204 included therein and/or by instructions 220 that can be fetched by the processor 202 from a storage medium 218. The storage medium 218 may be co-located with the controller 200 as shown, or it may be located elsewhere and be communicatively coupled to the controller 200.

The controller 200 can be a stand-alone programmable system, or it can be a programmable module located in a much larger system. For example, the controller 200 may be part of a commissioning device like the device 103, or it may be part of a smart phone or tablet device. The controller 200 may include one or more hardware and/or software components configured to fetch, decode, execute, store, analyze, distribute, evaluate, and/or categorize information. Furthermore, the controller 200 can include an input/output (I/O) module 214 that can be configured to interface with a plurality of sensors, such as an image sensor including an array of photodetectors or such as, generally, one or more light sensors.

The processor 202 may include one or more processing devices or cores (not shown). In some embodiments, the processor 202 may be a plurality of processors, each having either one or more cores. The processor 202 can be configured to execute instructions fetched from the memory 204, i.e. from one of memory blocks 212, 210, 208, or memory block 206, or the instructions may be fetched from the storage medium 218, or from a remote device connected to the controller 200 via a communication interface 216.

Furthermore, without loss of generality, the storage medium 218 and/or the memory 204 may include a volatile or non-volatile, magnetic, semiconductor, tape, optical, removable, non-removable, read-only, random-access, or any type of non-transitory computer-readable computer medium. The storage medium 218 and/or the memory 204 may include programs and/or other information that may be used by the processor 202. Furthermore, the storage medium 218 may be configured to log data processed, recorded, or collected during the operation of controller 200. The data may be time-stamped, location-stamped, cataloged, indexed, or organized in a variety of ways consistent with data storage practice.

In one embodiment, for example, the memory block 206 may include instructions that form a commissioning program, which when executed, cause the processor 202 to execute a commissioning method. The operations executed by the processor 202 when running such a program may include receiving a signal indicative of a network address of a luminaire. The luminaire may include a visible light communication module configured to encode the network address associated with the luminaire into a pattern of light pulses representative of the network address. Further, receiving the signal may include transducing the pattern of light pulses into the signal via a sensor coupled to the processor and routing the signal to the processor. The operations further include generating a database entry in a database accessible the processor, wherein the database entry associates the network address with a physical address of the luminaire.

FIG. 3 depicts a flow chart of a method 300 that can be used for commissioning one or more luminaires of a lighting system. The method 300 may being at step 302, and it may include, at step 304, receiving, by a commissioning device, a signal indicative of a network address of a luminaire. The luminaire includes a visible light communication module configured to encode the network address associated with the luminaire into a pattern of light pulses representative of the network address. As such, receiving the signal includes transducing the pattern of light pulses to obtain the signal via a sensor coupled to the commissioning device and routing the signal to the commissioning device.

The method 300 further includes, at step 306 mapping the received network address to a physical address of the luminaire. The mapping can include generating, by the commissioning device, a database entry in a database accessible the commissioning device, wherein the database entry associates the network address with a physical address of the luminaire. The method 300 may then end at step 308, or it may continue to step 310 where the commissioning device may be directed at another luminaire, in which case the method 300 restarts at step 302.

Generally, the embodiments of the present disclosure confer several advantages in commissioning a lighting system. For example, because VLC technology can be added at minimal to no cost depending on the LED Driver being used by a luminaire, the embodiments do not increase the deployment cost of the lighting controls hardware. Furthermore, even when an additional BLUETOOTH® radio is added to facilitate the distribution of VLC identifiers, the hardware cost increase is minimal.

As such, when compared to the two traditional methods of commissioning lighting controls, the embodiments will be faster and less complex. This will allow a reduction of labor cost during the setup of such a system, and even the potential to make this setup achievable by the end-user without the need to hire a commissioning company.

Generally, one example embodiment features a system for commissioning a lighting system. The system includes a processor and a memory having instructions stored thereon. The instructions, when executed by the processor, cause the processor to perform certain operations. The operations may include receiving a signal indicative of a network address of a luminaire.

The luminaire may include a visible light communication module configured to encode information indicative of a network address associated with the luminaire into a pattern of light pulses. The information (i.e., the network address) may be encoded in a visible light communication signal through any suitable means, such as, for example and not by limitation, phase-shift keying, frequency-shift keying, amplitude shift-keying, or on-off keying.

Further, the sensor which transduces the pattern of light pulses into the visible light communication sensor may be any suitable photosensitive element. In some embodiments, the sensor may be a photo sensor such as a photodiode. In other embodiments, the sensor may be an image sensor such as a charge coupled device (CCD) or complementary MOSFET (CMOS) camera element. In one exemplary embodiment, the information encoded in the light is captured by the image sensor by nature of the interaction between the rolling shutter of the image sensor and the modulated light.

Furthermore, receiving the signal may include transducing the pattern of light pulses into the signal via a sensor coupled to the processor and routing the signal to the processor. The operations may further include generating a database entry in a database accessible the processor, wherein the database entry associates the information indicative of the network address with a physical address of the luminaire.

The database entry may be generated in a database in which the network address and the physical location of the luminaire are stored. The database can be any data storage means present on the commissioning device. For example, the information can be saved to a file store temporarily or permanently on the smartphone or commissioning device. Alternatively, the database can also be remote from the commissioning device and accessed via any networking method available to the commissioning device. For example, the information can be transmitted to a remote data store via a WiFi, cellular, or Bluetooth Low Energy connection. The remote data store may be protected from unauthorized access, and it may require authentication protocols in order to be accessed for either saving or reading or both. It should be understood that the term database includes conventional relational database systems as well as any other means of persisting stored information, such as file based storage.

In the above-described embodiment, the operations further include programming the network address in a memory location of the visible light communication module. The programming may include inscribing the network address into the memory location as a factory setting or by transmitting the network address to the processor utilizing a remote device, such as a commissioning device, for example.

The pattern of light pulses may be is invisible to the human eye, either through an infrared link or by modulating the pattern on the light already being emitted by the luminaire but at a frequency at which the human eye cannot perceive the pattern. Further, the visible light communication module included in the luminaire may have additional functionality. For example, the visible light communication module may be configured to provide indoor positioning functionality to the luminaire.

Furthermore, generally, in an example method according to the teachings provided herein, visible light communication can be used to simplify the commissioning of a wireless lighting control system, thereby reducing the cost of ownership for such a system. As previously mentioned in relation to traditional commissioning methods, a challenge in commissioning a lighting system is mapping each wireless node's network address to a physical location within a space. In the example method, each luminaire is enabled with a low-cost visible light communication module. This enables a commissioning agent to capture that fixture's ID remotely using a commissioning device. Further, using a pre-prepared database of network addresses, the commissioning device can select the lighting controls network address that corresponds to the physical location.

Those skilled in the relevant art(s) will appreciate that various adaptations and modifications of the embodiments described above can be configured without departing from the scope and spirit of the disclosure. Therefore, it is to be understood that, within the scope of the appended claims, the disclosure may be practiced other than as specifically described herein.

What is claimed is:

1. A system for commissioning a lighting system, the system comprising:
a processor;
a memory including instructions that, when executed by the processor, cause the processor to perform operations including:
receiving a signal indicative of a network address of a luminaire including a visible light communication module configured to encode information indicative of the network address associated with the luminaire into a pattern of light pulses, wherein the receiving includes transducing the pattern of light pulses into the signal via a sensor coupled to the processor and routing the signal to the processor; and
generating a database entry in a database accessible the processor, wherein the database entry associates the information indicative of the network address with a physical address of the luminaire.

2. The system of claim 1, wherein the operations further include programming the information indicative network address in a memory location of the visible light communication module.

3. The system of claim 2, wherein the programming includes inscribing the information indicative of the network address into the memory location as a factory setting.

4. The system of claim 2, wherein the information indicative of the network address is the network address.

5. The system of claim 2, wherein the information indicative of the network address is a visible light communication identifier.

6. The system of claim 2, wherein the programming includes inscribing the information indicative of network address into the memory location by transmitting the information indicative of the network address to the processor utilizing a remote device.

7. The system of claim 5, wherein the transmitting is achieved wirelessly.

8. The system of claim 1, wherein the pattern of light pulses is invisible to the human eye.

9. The system of claim 1, wherein the visible light communication module is further configured to provide indoor positioning functionality to the luminaire.

10. The system of claim 1, wherein the database entry further associates the information indicative of the network address with a zone that includes at least one other luminaire.

11. A method of commissioning a luminaire, the method comprising:
receiving, by a commissioning device, a signal indicative of a network address of the luminaire, wherein the luminaire includes a visible light communication module configured to encode information indicative of the network address associated with the luminaire into a pattern of light pulses, wherein the receiving includes transducing the pattern of light pulses into the signal via a sensor coupled to the commissioning device and routing the signal to the commissioning device; and
generating, by the commissioning device, a database entry in a database accessible the commissioning device, wherein the database entry associates the information indicative of the network address with a physical address of the luminaire.

12. The method of claim 11, further including programming, by the commissioning device, the information indicative of the network address or the network address in a memory location of the visible light communication module.

13. The method of claim 12, further including inscribing, by the commissioning device, the information indicative of the network address into the memory location as a factory setting.

14. The method of claim 12, further including inscribing the network address into the memory location by transmitting the network address to the processor utilizing a remote device.

15. The method claim 14, wherein the transmitting is achieved wirelessly.

16. The method of claim 11, wherein the pattern of light pulses is invisible to the human eye.

17. The method of claim 11, wherein the visible light communication module is further configured to provide indoor positioning functionality to the luminaire.

18. The method of claim 11, wherein the database entry further associates the information indicative of the network address with a zone that includes at least one other luminaire

19. A non-transitory computer-readable medium including instructions that, when executed by a processor, cause the processor to perform operations comprising:
receiving a signal indicative of a network address of a luminaire including a visible light communication module configured to encode information indicative of the network address associated with the luminaire into a pattern of light pulses representative of the network address, wherein the receiving includes transducing the pattern of light pulses into the signal via a sensor coupled to the processor and routing the signal to the processor; and
generating a database entry in a database accessible the processor, wherein the database entry associates the information indicative of the network address with a physical address of the luminaire.

20. The non-transitory computer-readable medium of claim 17, wherein the operations further include programming the network address in a memory location of the visible light communication module.

21. The non-transitory computer-readable medium of claim 18, wherein the programming includes inscribing the network address into the memory location as a factory setting.

22. The non-transitory computer-readable medium of claim 18, wherein the programming includes inscribing the network address into the memory location by transmitting the network address to the processor utilizing a remote device.
